(19) United States
(12) Patent Application Publication
(10) Pub. No.: US 2026/0118679 A1
(43) Pub. Date: Apr. 30, 2026

(54) OPTICAL SYSTEM WITH DUAL REFLECTOR COUPLING-IN TO LIGHTGUIDE

(71) Applicant: LUMUS LTD., Ness Ziona (IL)

(72) Inventors: Ronen CHRIKI, Lod (IL); Eitan RONEN, Rechovot (IL)

(21) Appl. No.: 19/149,608

(22) PCT Filed: Jul. 23, 2024
(86) PCT No.: PCT/IL2024/050720

§ 371 Date: Jul. 21, 2025

Related U.S. Application Data
(60) Provisional application No. 63/528,386, filed on Jul. 23, 2023.
(60) Provisional application No. 63/534,871, filed on Aug. 28, 2023.

(51) Int. Cl. G02B 27/01; G02B 5/04; G02B 27/00; G02B 27/30

(52) U.S. Cl. CPC G02B 27/0172; G02B 5/04; G02B 27/0081; G02B 27/30; G02B 2027/0178

(57) ABSTRACT

An optical system (1) includes a lightguide (100) and an image projector (200). A coupling-in configuration includes a first planar reflector (250) forming an acute angle β with a major surface (101) of the lightguide and extending across a thickness h of the lightguide, and a second planar reflector (271) external to the lightguide and inclined at an angle 2β thereto. Light rays passing through a first part (D₁) of the projector exit aperture impinge directly on the first planar reflector (250) and are reflected to impinge on major surface (101) of the lightguide at a first angle of incidence and light rays passing through a second part (D₂) of the projector exit aperture impinge on the second planar reflector (271), are reflected towards the first planar reflector (150) and impinge on the second major surface (102) at the same angle of incidence.

### FIELD AND BACKGROUND OF THE INVENTION

The present invention relates to optical systems and, in particular, it concerns an optical system in which a dual reflector arrangement is used to couple an image into a lightguide optical element.

Lightguide-based displays employ a lightguide, typically in the form of a slab having mutually parallel front and rear surfaces, to guide an image in front of the eye of the user for coupling out towards the eye for viewing. In some cases, the lightguide may achieve one- or two-dimensional optical aperture expansion by progressively redirecting the light within the lightguide and/or in the coupling out process. Progressive redirection of the light is typically performed either by a set of embedded partial reflectors or by diffractive optical elements.

Coupling an image into the lightguide presents design challenges. Optimal image uniformity is achieved when the image light “fills” the lightguide thickness, i.e., where all rays of the image and its reflection are present at every point within the lightguide thickness. This often requires a relatively large projector and coupling configuration and dictates geometrical layouts which may be at odds with ergonomic and aesthetic design considerations.

### SUMMARY OF THE INVENTION

The present invention is an optical system in which a dual reflector arrangement is used to couple an image into a lightguide optical element.

According to the teachings of an embodiment of the present invention there is provided, an optical system comprising: (a) a lightguide having first and second mutually parallel major surfaces for supporting propagation of image light by internal reflection at the major surfaces, the major surfaces being separated by a thickness of the lightguide, the lightguide including a coupling-out arrangement for coupling out image light from the lightguide towards an eye of an observer; (b) an image projector for projecting light corresponding to a collimated image through a projector exit aperture; and (c) a coupling-in configuration deployed to couple in the light from the image projector so as to propagate within the lightguide, the coupling-in configuration comprising: (i) a first planar reflector forming an acute angle β with the major surfaces and extending across the thickness of the lightguide, and (ii) a second planar reflector associated with the first major surface external to the lightguide and inclined to the first major surface at an angle 2β such that a plane of the second planar reflector corresponds to the first major surface under reflection in a plane of the first planar reflector, wherein the image projector is aligned with the coupling-in configuration such that, for each pixel of the collimated image, light rays corresponding to that pixel passing through a first part of the projector exit aperture impinge directly on the first planar reflector and are reflected to impinge on the first major surface at a first angle of incidence and light rays corresponding to that pixel passing through a second part of the projector exit aperture impinge on the second planar reflector, are reflected towards the first planar reflector and are reflected from the first planar reflector to impinge on the second major surface at the first angle of incidence.

According to a further feature of an embodiment of the present invention, the second planar reflector is formed at a surface of a prism attached to the first major surface.

According to a further feature of an embodiment of the present invention, the lightguide is formed primarily from a material having a first refractive index and wherein the prism is formed from a material having a second refractive index.

According to a further feature of an embodiment of the present invention, there is also provided a compensation wedge formed from material with the first refractive index interposed between the prism and the first major surface.

According to a further feature of an embodiment of the present invention, a portion of the lightguide adjacent to the first planar reflector is formed from a material having the second refractive index, the second refractive index being greater than the first refractive index.

According to a further feature of an embodiment of the present invention, the image projector is integrated with the prism, the image projector comprising a polarizing beam splitter deployed within the prism for directing light from an image plane via reflective collimating optics towards the first and second planar reflectors.

According to a further feature of an embodiment of the present invention, the reflective collimating optics is located behind the second planar reflector and wherein light from the image plane passes through the second planar reflector to reach the reflective collimating optics, is reflected back through the second planar reflector, and is reflected by the polarizing beam splitter at an oblique angle to the second planar reflector for coupling into the lightguide.

According to a further feature of an embodiment of the present invention, the angle β is between 35 degrees and 55 degrees.

According to a further feature of an embodiment of the present invention, the second planar reflector is perpendicular to the first major surface of the lightguide.

### BRIEF DESCRIPTION OF THE DRAWINGS

The invention is herein described, by way of example only, with reference to the accompanying drawings, wherein:

FIGS. 1A and 1B are schematic isometric views of optical systems, constructed and operative according to embodiments of the present invention, implemented as binocular near-eye displays with one-dimensional and two-dimensional aperture expansion of a projected image within a lightguide, respectively;

FIGS. 2A and 2B are schematic side views illustrating coupling-in of an image into a lightguide with reflective and diffractive coupling out, respectively;

FIGS. 3A-3C are partial schematic side views similar to FIG. 2A illustrating ray paths for a chief ray of an image, a shallowest angle ray and a steepest angle ray, respectively;

FIG. 3D is a view similar to FIGS. 3A-3C illustrating the size parameters of a coupling-in prism required to accommodate both the shallowest and ray and the steepest angle ray, and to fill the lightguide;

FIGS. 4A and 4B are schematic top and side illustrations, respectfully, showing directions of inclination of a glasses frame lightguide relative to a viewing direction of a user;

FIGS. 5A-5C are schematic side views illustrating a coupling-in arrangement from the optical systems of FIGS. 1A and 1B showing ray paths for chief rays of an image originating at a first part of a projector exit aperture, a second part of the projector exit aperture, and the entirety of the projector exit aperture, respectively;

FIGS. 6A and 6B are schematic side views similar to FIGS. 5A-5C illustrating ray paths for a shallowest angle ray and a steepest angle ray or an image, respectively;

FIG. 6C is a view similar to FIGS. 6A and 6B illustrating the size parameters of a coupling-in prism required to accommodate both the shallowest and ray and the steepest angle ray, and to fill the lightguide;

FIG. 7 is a view similar to FIGS. 5A-5C illustrating a possible ray path for generating a ghost image in certain implementations of the optical system;

FIG. 8 is a schematic side view similar to FIG. 7 illustrating a modification of the coupling-in configuration to eliminate the ghost ray path of FIG. 7;

FIG. 9A is a view similar to FIGS. 5A-5C illustrating another possible ray path for generating a ghost image in certain implementations of the optical system;

FIG. 9B is a schematic side view similar to FIG. 9A illustrating a modification of the coupling-in configuration to eliminate the ghost ray path of FIG. 9A;

FIGS. 10A and 10B are schematic side views similar to FIGS. 5A-5C illustrating an option of providing a high refractive index section of the lightguide adjacent to a coupling-in region, without and with a compensation wedge prism, respectively;

FIG. 11 is a schematic side view similar to FIGS. 5A-5C illustrating a first option for integrating an image projector with a coupling prism for coupling an image into the lightguide; and

FIG. 12 is a schematic side view similar to FIGS. 5A-5C illustrating a second option for integrating an image projector with a coupling prism for coupling an image into the lightguide.

### DESCRIPTION OF THE PREFERRED EMBODIMENTS

The present invention is an optical system in which a dual reflector arrangement is used to couple an image into a lightguide optical element.

The principles and operation of optical systems according to the present invention may be better understood with reference to the drawings and the accompanying description.

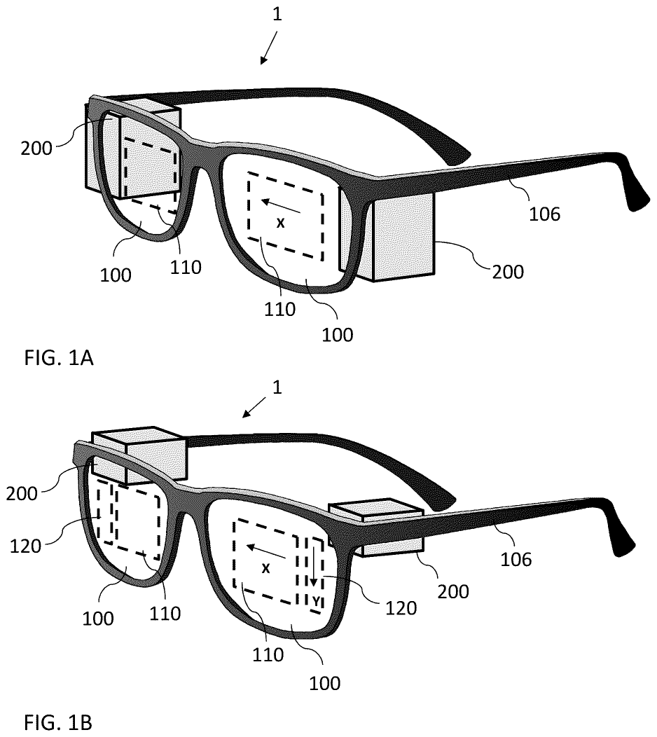

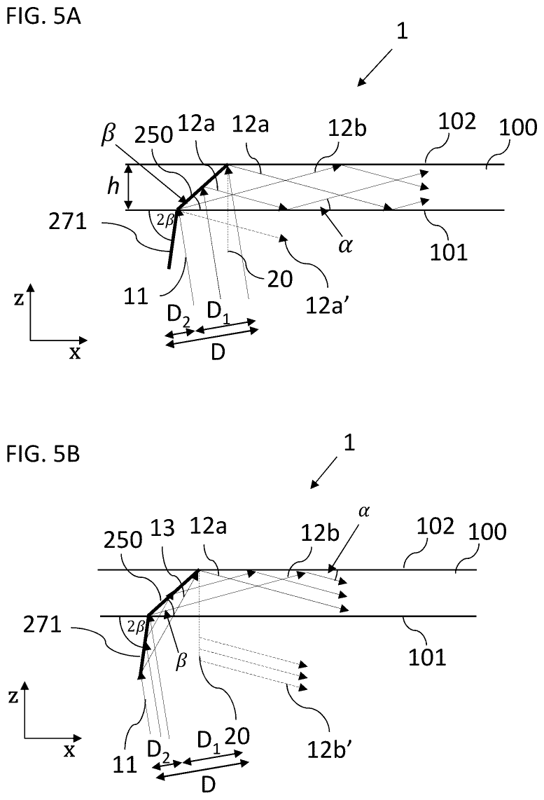

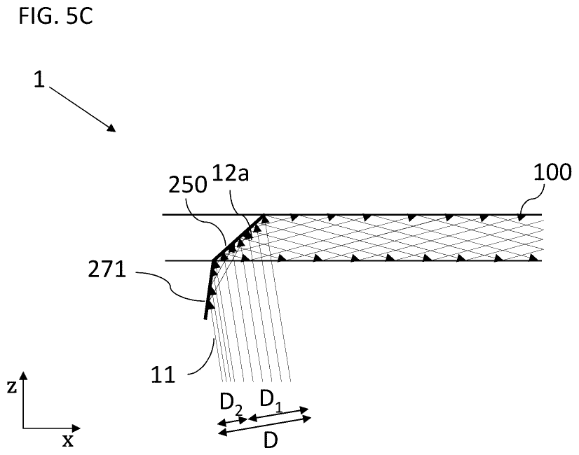

By way of introduction, FIGS. 1A-4B present a typical usage scenario of the present invention, illustrate some of the conventional approaches to coupling-in configurations for such applications, and define various terminology and parameters that are used to explain features of the present invention. Details of various preferred implementations of the present invention are then presented with reference to FIGS. 5A-11.

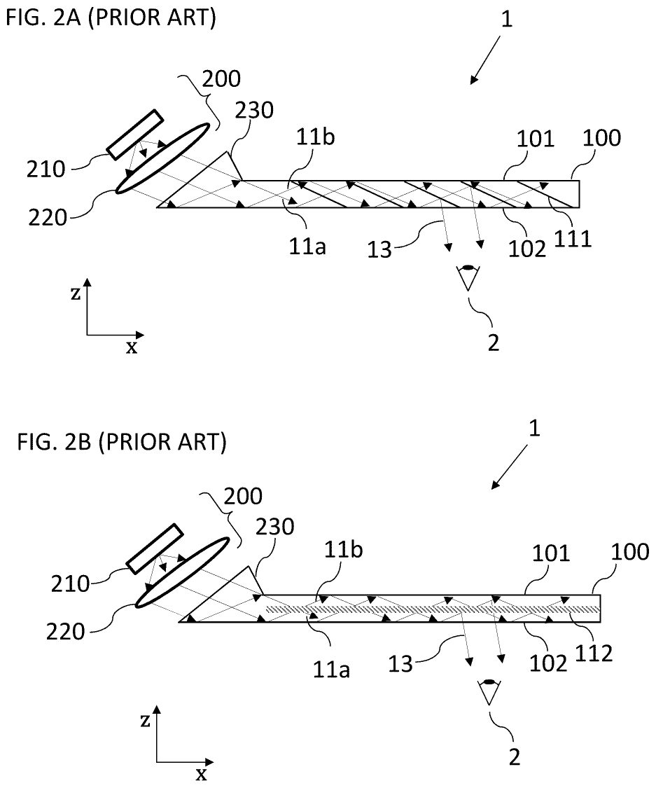

FIGS. 1A and 1B are schematic isometric views of a head mounted display 1. An image is projected by a projector 200 and coupled into the lightguide optical element (LOE) 100, interchangeably referred to as a “waveguide” or “substrate,” which are supported by a support structure, here shown in the form of a glasses frame 106. The waveguide is usually composed of an optical substrate that has two parallel major surfaces. Light corresponding to a projected image that is coupled into waveguide 100 is trapped by total internal reflection (TIR). Due to the TIR, the image in FIG. 1A propagates mostly in the x-axis direction. Waveguide 100 includes embedded elements that progressively couple the light out of the cavity towards the eye of the observer, thereby achieving optical aperture expansion in the x-direction. These elements lie in region 110 and may be partially reflecting surfaces (or “facets”) 111 embedded inside the substrate as illustrated in FIG. 2A, or volume or surface gratings 112 as illustrated in FIG. 2B. The examples in the subsequent disclosure refer primarily to implementations with partially reflecting surfaces, but the teachings of the present invention apply throughout equally to waveguides with diffractive elements, or a combination of diffraction and reflective elements.

The waveguide 100 may include more than one set of co-parallel elements, as presented in FIG. 1B, where embedded elements in a first region 120 progressively redirect the image light within the substrate, thereby expanding the effective optical aperture approximately in the y-axis direction, while embedded elements in the second region 110 expand light approximately in the x-axis direction. Here too, the two-dimensional aperture expansion may employ reflective elements, diffractive elements, or some combination of the two.

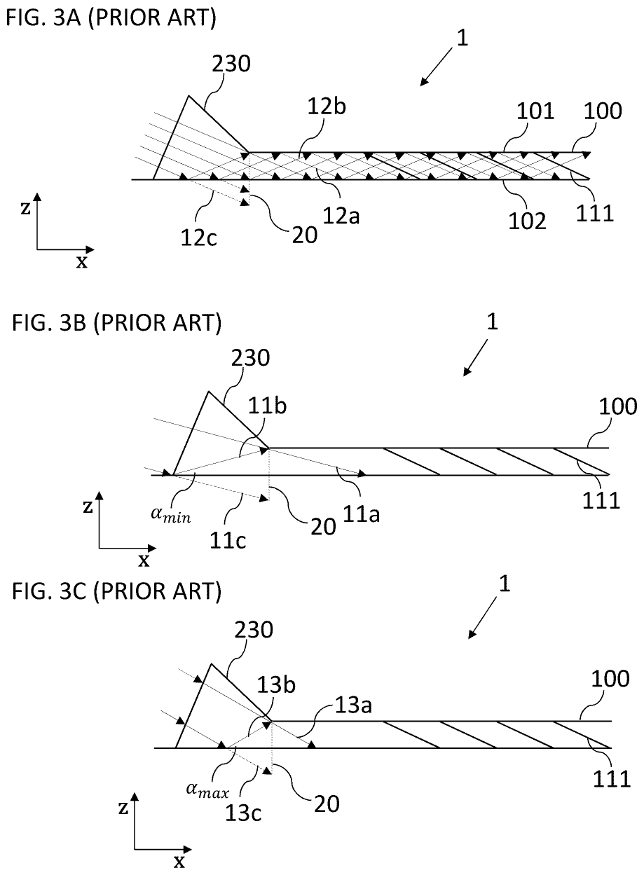

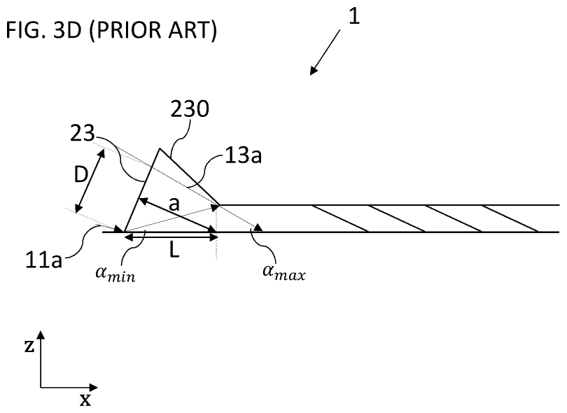

FIGS. 2A-3D illustrate conventional geometry for coupling light corresponding to an image into the waveguide, shown in one-dimensional expansion scenario but applicable also to two-dimensional aperture expansion scenarios. In FIGS. 2A and 2B, an image from a display 210 is collimated by a lens 220, and is coupled into the waveguide 100 through a coupling-in prism 230. The ascending rays 11b and descending rays 11a describe the image and conjugated (inverted) image between which energy is interchanged as they propagate through the waveguide, and that are trapped by TIR between the major surfaces of the waveguide, 101 and 102. When the rays 11b are reflected by one of the embedded partially reflecting surfaces 111 in FIG. 2A or diffractive optical element 112 in FIG. 2B, they are redirected to rays 13 which are no longer trapped by TIR and are therefore coupled out of the waveguide towards the “eye motion box” (EMB), corresponding to the region from which the user's eye 2 views the image.

An image coupled into the waveguide is composed of different fields (different pixels which arrive at different locations on the retina of the user), that can each be described by a set of parallel rays. FIG. 3A shows descending and ascending rays 12a and 12b, that describe the central field. In order to achieve a uniform image at the output, the effective aperture 20 must be filled. The size of the effective aperture 20 in a direction normal to the waveguide (z-axis in FIG. 3A) is double the thickness of the waveguide, defined between the cutoff edge at the end of prism 230 and the mirror image of that edge in lower waveguide surface 102. Typically, prism 230 is constructed such that the light-entry surface is normal to the central field, thereby minimizing dispersion artifacts.

FIGS. 3B and 3C show the two extreme field locations that propagate through the waveguide system 1 at angles αₘᵢₙ and αₘₐₓ, with respect to the waveguide major surfaces. In FIG. 3B, rays propagate at the lowest angle with respect to the major surface, αₘᵢₙ, in descending and ascending rays 11a and 11b, and in FIG. 3C, light propagates at the highest angle with respect to the major surfaces of the waveguide, αₘₐₓ in descending and ascending rays, 13a and 13b. The field of view (FoV) guided by the waveguide in the x-z plane is given by

$$F oV = {α}_{max} - {α}_{min} .$$

Considering the input structure in these figures, one can estimate the size of the required projector as illustrated in FIG. 3D based on: (a) the size D, defined as the region on the back (light entrance) surface of prism 230 where light rays impinge the surface in order to reach the aperture 20 at the required field of view; and (b) the distance a between the center of the input aperture 20 and the back surface of the prism 230. For a waveguide of thickness h, these size parameters are given by

$$\begin{matrix}α = \frac{h cos [ \frac{( {α}_{min} + {α}_{max} )}{2} ]}{tan ( {α}_{min} )} , \\ D = \frac{h sin ( {α}_{min} + {α}_{max} )}{sin ( {α}_{min} ) cos [ \frac{( {α}_{max} - {α}_{min} )}{2} ]} .\end{matrix}$$

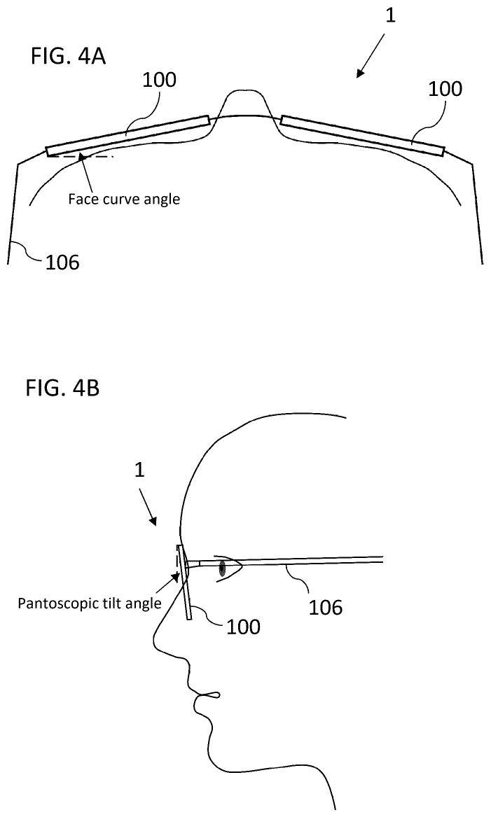

These parameters diverge for small values of αₘᵢₙ, and accordingly the size of the projector in waveguides with small min becomes large. Since the orientation of the projector in FIGS. 2A-3D is dictated by the geometric parameters of the waveguide, this can lead to cumbersome systems, especially when αₘᵢₙ is small. It is therefore advantageous to design an input coupling arrangement that provides additional flexibility regarding the orientation of the projector. Furthermore, the waveguide is often tilted for aesthetic or other reasons, as illustrated in FIGS. 4A and 4B, and it is often desired to position and orientate the image projector so that it can be conveniently and compactly incorporated in frame 106.

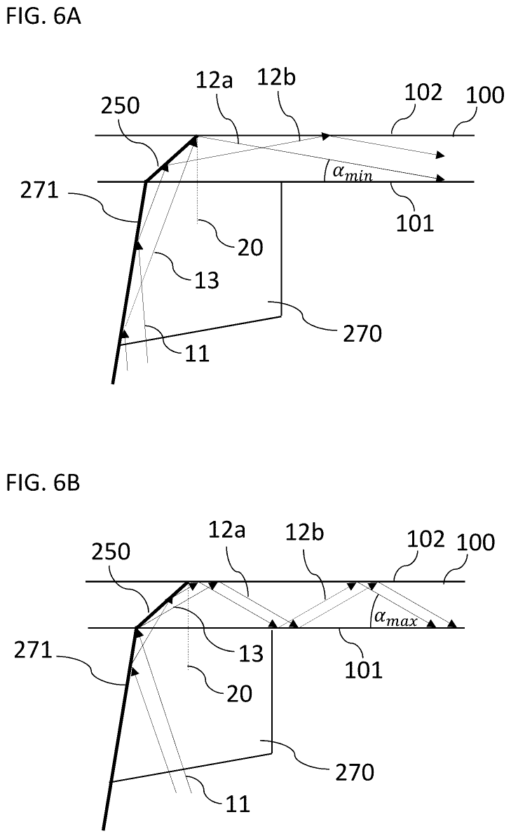

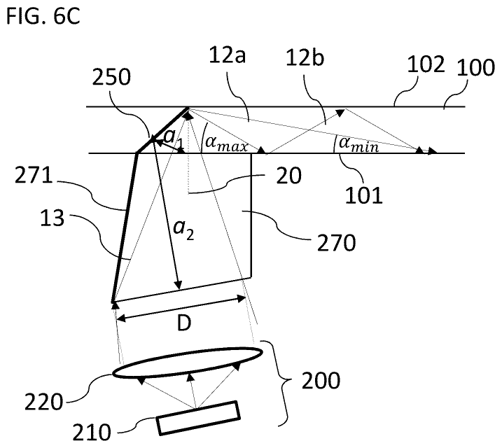

In the above context, certain embodiments of the present invention as presented in FIGS. 5A-11 provide optical system 1, which is typically a display system such as illustrated in FIGS. 1A and 1B, including a lightguide 100 having first and second mutually parallel major surfaces 101, 102 for supporting propagation of image light 12a, 12b by internal reflection at the major surfaces. Major surfaces 101, 102 are separated by a thickness h of the lightguide. The lightguide also includes a coupling-out arrangement, such as those illustrated in FIG. 2A or 2B above, for coupling out image light from the lightguide towards the eye of an observer. The optical system also includes an image projector for projecting light corresponding to a collimated image through a projector exit aperture D. The projector is represented schematically in FIG. 6C as an image source 210 and collimating optics 220.

It is a particular feature of certain preferred embodiments of the present invention that optical system 1 further includes a coupling-in configuration, deployed to couple in the light from the image projector so as to propagate within the lightguide, that includes a first planar reflector 250 forming an acute angle β with the major surfaces and extending across the thickness of lightguide 100, and a second planar reflector 271. Second planar reflector 271 is associated with first major surface 101 external to lightguide 100 and inclined to first major surface 101 at an angle 2β. Thus, a plane of second planar reflector 271 corresponds to the plane of first major surface 101 under reflection in a plane of first planar reflector 250. The plane of second planar reflector may be considered a “conjugate plane” with first major surface 101 under reflection in the plane of first planar reflector 250. The plane of first planar reflector 250 typically also bisects the angle between first major surface 101 and the plane of second planar reflector 271, although it may be somewhat offset from the line of intersection between those planes, as will be discussed below.

Alignment of the image projector with the coupling-in configuration is chosen such that, for each pixel of the collimated image, light rays 11 corresponding to that pixel passing through a first part D₁ of the projector exit aperture impinge directly on the first planar reflector 250 and are reflected as rays 12a to impinge on the first major surface 101 at a first angle of incidence α, as shown in FIG. 5A, and light rays 11 corresponding to that pixel passing through a second part D₂ of the projector exit aperture impinge on the second planar reflector 271, are reflected towards the first planar reflector 250 and are reflected from the first planar reflector as rays 12b to impinge on second major surface 102 at the first angle of incidence α, as shown in FIG. 5B. The combined rays exiting the entire projector exit aperture D thus fill the lightguide, as illustrated in FIG. 5C.

At this stage, it will be appreciated that the coupling-in configuration of the present invention provides additional design flexibility, and is particularly conducive, for example, to a glasses form-factor implementation, with deployment of the projector extending outwards from the plane of the lightguide adjacent to or integrated with sides of a glasses frame. The angle β can be chosen according to various design considerations and is typically in the range between 35 degrees and 55 degrees. The corresponding angle of second planar reflector 271 is 70-110 degrees to the major planar surface 101. In certain cases, it may be preferable to employ a second planar reflector 271 deployed perpendicular to major surface 101, since this facilitates manufacture, and may avoid the need for a dispersion-correcting wedge prism as will be discussed below. This corresponds to an angle β of 45 degrees for the inclination of first planar reflector 250.

FIG. 5A shows the trajectory of rays 11 that impinge the coupling-in mirror 250. As shown, rays 11 are reflected by coupling-in mirror 250 to the descending rays 12a that are trapped in the substrate by total internal reflection. The figure also shows the full aperture 20 of the waveguide, which is of size 2h (h being the thickness of the waveguide), as explained above, and a virtual ray 12a′ that denotes the trajectory of rays 12a were they not reflected by major surface 101. Ray 12a′ indicates the size of the aperture 20 that is filled by mirror 250, which is given by

$$h ( 1 + \frac{tan α}{tan β} ) .$$

FIG. 5B shows the trajectories of rays 11 which impinge the coupling mirror 271. Rays 11 are reflected by coupling-in mirror 271 to rays 13, which impinge on coupling-in mirror 250, which in turn reflects rays 13 to ascending rays 12b. The figure also shows the aperture 20, together with rays 12b′, which represent a mirror image of rays 12b reflected from 271 and 250 around the major surface 101. Rays 12b′ indicate the relative portion of the aperture 20 that is being filled by rays 11 impinging mirror 271, which is given by

$$h ( 1 - \frac{tan α}{tan β} ) .$$

Clearly, the trajectories of rays 11 in FIGS. 5A and 5B together fill the entire aperture 20, as shown in FIG. 5C.

FIGS. 6A and 6B show the trajectories of the extreme fields in optical system 1, forming an angle αₘᵢₙ and αₘₐₓ with the major surfaces of waveguide 100. The entire field of view determines the required illumination of the input aperture of the waveguide. In order to minimize chromatic aberrations, it is advantageous to place a coupling-in prism 270 with an input surface that is perpendicular to the central field illuminated from the projector, as illustrated in FIG. 6C. The prism is bonded to the waveguide 100 using a low refractive index adhesive or alternatively may be mounted with a small air gap from the waveguide 100, so as to maintain conditions for TIR of coupled-in rays 12a at major surface 101. The side surface of prism 270 may be coated to form the second planar reflector 271, or that function may be provided also by TIR, depending on the range of incident angles to be handled. For clarity of presentation, prism 270 is not shown in all of the drawings. However, it should in most cases be understood to be present except where otherwise stated.

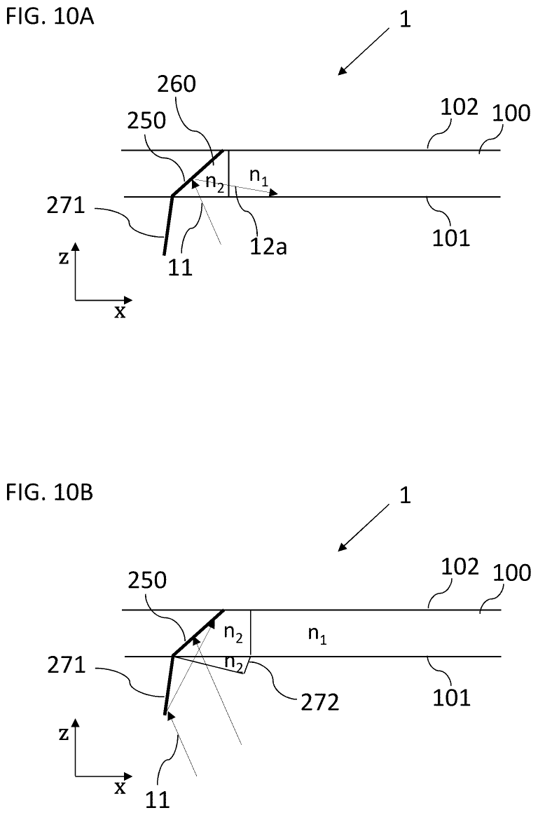

As in FIG. 3D above, the size D of the footprint of rays on the input prism 270, together with the distance from the center of the aperture 20 to the coupling-in surface of the prism 270, a1+a2, determine the required size of the projector. This configuration ‘folds’ the arrangement of FIGS. 2A-3D, and therefore a=a1+a2 and D are given by the same equations as were quoted above. If the material of 270 is different from that of the waveguide's substrate, the coupling-in structure 20) may cause chromatic aberrations and/or misalignment between the coupled-in downward-image 12a and the upward-image 12b. A correction wedge prism 272 (discussed further below with reference to FIG. 10B, and which may be composed of several materials—not shown) can compensate for such distortions.

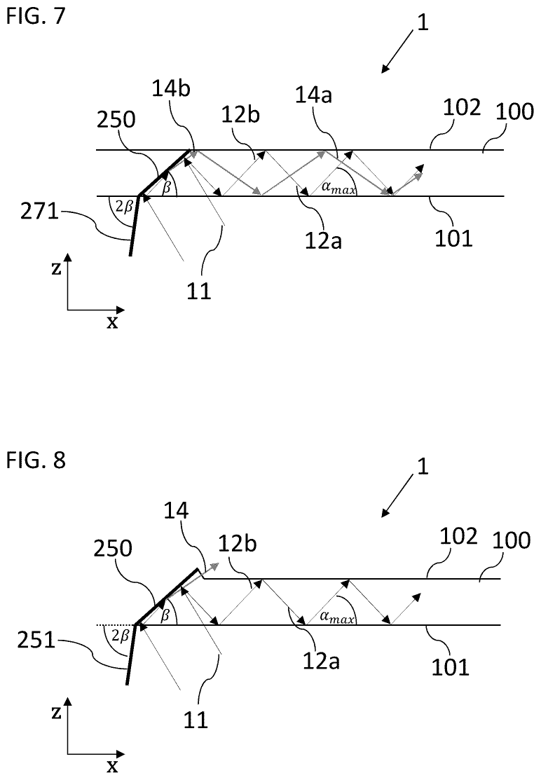

FIGS. 7-9B address certain special cases of ray paths which might lead to ghost images, and how they can be suppressed. Referring to FIG. 7, this illustrates a case in which the angle αₘₐₓ of the field with the steepest angle within the waveguide is larger than the elevation angle β of the planar reflector 250, i.e., αₘₐₓ>β. In this case, an ascending ray 12b may impinge on reflector 250 and be reflected to a deleterious ray 14, thereby forming a ghost image, as shown in FIG. 7. This ghost image can be suppressed by implementing reflector 250 so as to slightly protrude from major surface 102 as shown in FIG. 8, thereby forming a cutoff edge which trims the unwanted ray 14. This solution is at the cost of slightly reduced efficiency, due to the incidental trimming and discarding of some of the image light rays 12b.

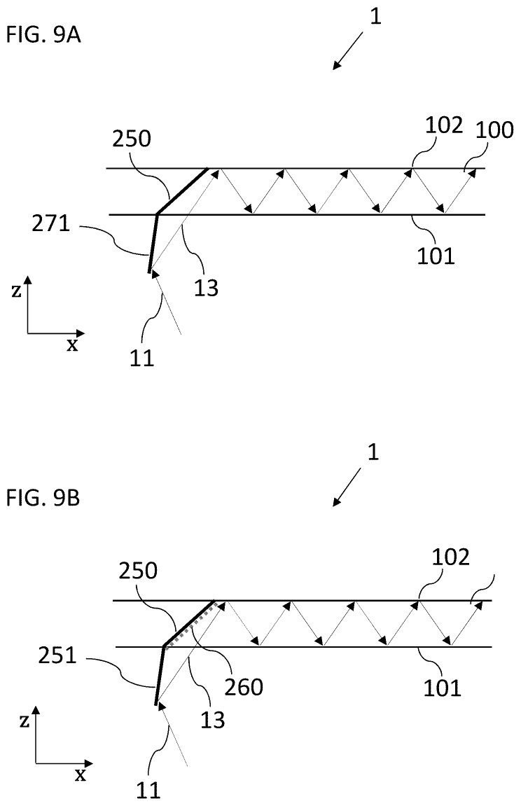

FIG. 9A shows that light rays 11 that impinge the coupling-in mirror 271 may be reflected to rays 13 and coupled into the waveguide if they ‘miss’ coupling-in mirror 250. This may cause a ghost image at the output. In an optimally designed system, illumination optics associated with the image source (not described herein in detail) together with the collimating optics achieve “pupil imaging” from an illumination pupil to the entrance to the lightguide 20 through which it should be possible to largely eliminate stray rays such as ray 13 of FIG. 9A. However, if such rays are found to be problematic, the resulting ghost may be eliminated through polarization management, as illustrated with reference to FIG. 9B.

Specifically, to eliminate this ghost, the implementation illustrated in FIG. 9B includes a quarter wave plate 260 that is placed near first planar reflector 250, thereby rotating the polarization of all rays 13 that are reflected by reflector 250. If the injected rays are polarized, the polarization of rays 12a, 12b in the waveguide is orthogonal to the polarization of rays 13 that are coupled into the waveguide. Therefore, the deleterious rays 13 inside the waveguide can be suppressed by placing a polarizer inside the waveguide, or alternatively, by employing polarization-sensitive coatings on the waveguide facets.

In certain preferred implementations of the present invention, coupling prism 270 is formed from material with the same refractive index as lightguide 100, thereby avoiding issues of chromatic aberrations and image smearing or doubling that can be introduced by an interface between materials with differing refractive indices. However, in certain cases, there may be advantages to the use of higher index materials than are typically used for lightguide 100. Specifically, ray 11 must penetrate the waveguide, and after being reflected by the coupling-in reflector (mirror) 250, ray 12a must be trapped inside the waveguide by TIR. Particularly where prism 270 is bonded to the lightguide using low-index adhesive, a relatively small difference between refractive indices between the material of the lightguide and the low-index adhesive places a strict constraint on the angular orientation of rays 11 and 12, as well as on the coupling-in reflector 250. This constraint can be made less limiting if at least the coupling-in region of the waveguide is made from a material having a higher refractive index n₂, as shown in FIG. 10A. Using a higher refractive index n₂ in a prism 260 that is placed below the coupling-in mirror 250, allows more design flexibility and guiding larger fields of view, for example, maintaining a larger differential between the refractive indices of the prism 260 and low-index adhesive used to attach the coupling prism. Although the entire lightguide 100 could in principle be made from material with refractive index n₂, materials with a high refractive index may be expensive and/or heavier than other optical materials and may be more difficult to match where index-matched adhesives are required. For these reasons, it may be preferable to form only the coupling-in region from higher index material and provide a joint at which the remainder of the lightguide switches to lower-index material. To minimize chromatic aberrations and/or misalignment between the coupled-in downward-image 12a and the upward-image 12b, the interface between prism 260 and the waveguide substrate is most preferably roughly perpendicular to the major surfaces of the waveguide.

The interface between coupling prism 270 and waveguide 100 or prism 260 may also be a source of chromatic aberration and misalignment between the coupled-in downward-image 12a and the upward-image 12b if coupling prism 270 has a different refractive index from the material of waveguide 100 or prism 260 that underlies it. Although the description thus far as referred to the orientation of second planar reflector 271 as being at an angle 2β, it is possible to achieve at least a partial correction for differences in refractive index between the lightguide and the waveguide or coupling prism by changing the orientation so that the plane of reflector 271 is still a reflection of lightguide after taking the differences in refractive index into account. Typically, such a correction is non-optimal as it does not work uniformly for different fields of the image, and it will typically only be sufficient for small FOV displays.

A more comprehensive correction for the mismatch of refractive indices which could cause blurred or doubled images is illustrated in FIG. 10B. In this case, an additional wedge prism 272, made from the same material as prism 260 (or the waveguide, when no prism 260 is used), is inserted between the coupling prism 272 and first major surface 101 so as to present a front surface that is equally inclined relative to rays 11 and 13. The angle of the wedge is (90-2B) degrees, resulting in the front surface being perpendicular to reflector 271. In this manner, rays 11 and 13, which are associated with the same field, undergo the same refractive deflection at the interface between coupling-in prism 270 and wedge prism 272. As before, low index adhesive or an air gap must be present between wedge prism 260 and the waveguide.

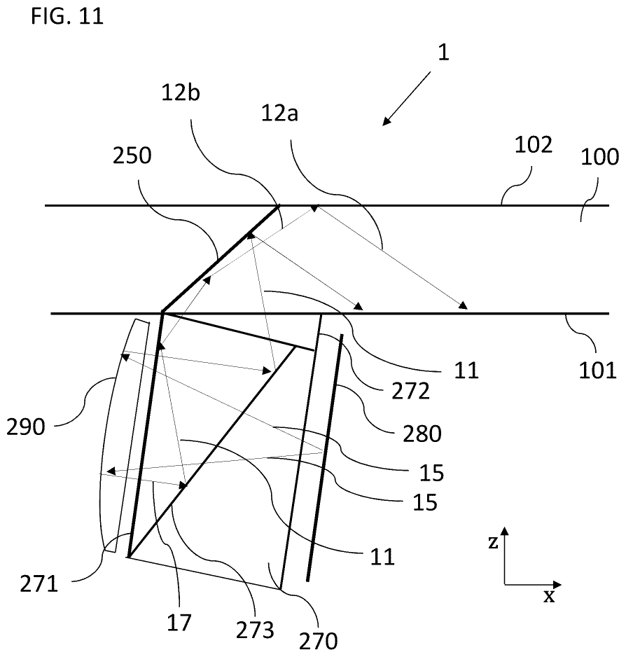

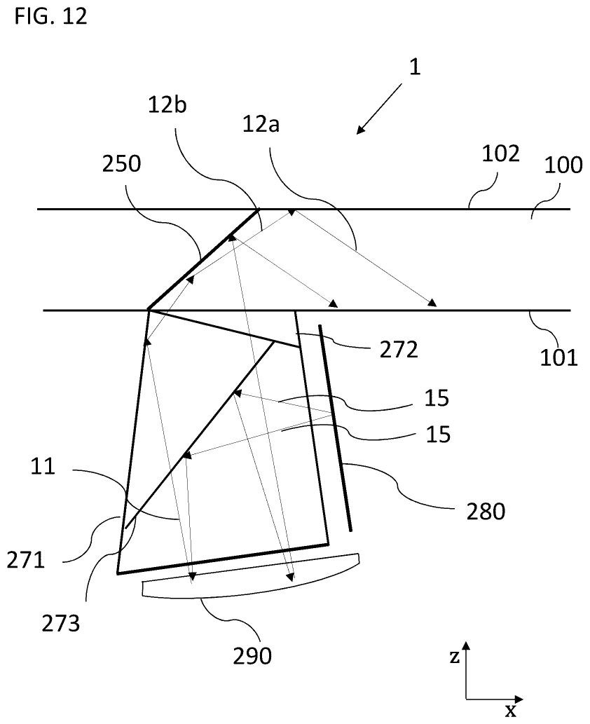

Turning now to FIGS. 11 and 12, in certain particularly advantageous implementations, instead of a separate self-contained image projector juxtaposed to prism 270, the image projector may be integrated with the prism, preferably by use of a polarizing beam splitter 273 deployed within the prism for directing light from an image plane via reflective collimating optics towards the first and second planar reflectors. This results in a more compact structure.

A first such implementation is illustrated in FIG. 11, where prism 270 includes polarized beam splitter (PBS) 273. A display device 280, typically defining an image plane, is placed near one face of the PBS prism 270, and a collimating lens (reflective collimating optics) 290 is placed on the other side of the PBS prism 270. In this case, the reflective collimating optics 290 is located behind the second planar reflector 271 so that image light from display device 280 passes through PBS 273 and through second planar reflector 271 to reach the reflective collimating optics 290, is reflected back through second planar reflector 271, and is reflected by the polarizing beam splitter 273 at an oblique angle to both the first and second planar reflectors 250 and 271 for coupling in to the lightguide.

The display device may consist of a spatial light modulator (SLM) such as a liquid crystal on Silicon (LCOS) display, a liquid crystal display (LCD), an OLED or micro-LED display or a scanning laser arrangement. According to these different examples, display device 280 may be self-emitting, or it might be illuminated with an external light source, e.g. RGB LEDs, possibly through reflection of polarized light from PBS surface 273. The reflective collimating optics 290 may be a single lens, doublet or other lens combination including at least one reflective surface. The reflective collimating optics 290 is preferably separated from prism surface/reflector 271 by an air gap or may be bonded thereto with a low refractive index material, to provide the reflectance required at angled relevant to coupling in the image light into the lightguide as described above.

Rays 15 projected from a single pixel on the display device 280 are collimated by optics 290 and oriented as rays 17 after being reflected from 290. A quarter waveplate is placed between 270 and 290 (not shown), such that the polarization of the light is rotated after being reflected from the collimating lens 290. In this manner, rays 17 are reflected to rays 11 at the surface 273 for coupling into the waveguide.

FIG. 12 illustrates a variant implementation of optical system 1 which is structurally and functionally similar to FIG. 11. This implementation employs reflection of the image light rays 15 from display device 280 at PBS surface 273 and then, after collimation at reflective collimating optics 290 and rotation of polarization by a quarter waveplate associated with the collimating optics, the collimated rays are transmitted by the PBS surface 273 as rays 11 for coupling into the waveguide.

It will be appreciated that the above descriptions are intended only to serve as examples, and that many other embodiments are possible within the scope of the present invention as defined in the appended claims.

What is claimed is:

1. An optical system comprising:
(a) a lightguide having first and second mutually parallel major surfaces for supporting propagation of image light by internal reflection at said major surfaces, said major surfaces being separated by a thickness of said lightguide, said lightguide including a coupling-out arrangement for coupling out image light from the lightguide towards an eye of an observer;
(b) an image projector for projecting light corresponding to a collimated image through a projector exit aperture; and
(c) a coupling-in configuration deployed to couple in the light from said image projector so as to propagate within said lightguide, said coupling-in configuration comprising:
(i) a first planar reflector forming an acute angle β with said major surfaces and extending across the thickness of said lightguide, and
(ii) a second planar reflector associated with said first major surface external to the lightguide and inclined to said first major surface at an angle 2β such that a plane of said second planar reflector corresponds to said first major surface under reflection in a plane of said first planar reflector,
wherein said image projector is aligned with said coupling-in configuration such that, for each pixel of the collimated image, light rays corresponding to that pixel passing through a first part of the projector exit aperture impinge directly on said first planar reflector and are reflected to impinge on said first major surface at a first angle of incidence and light rays corresponding to that pixel passing through a second part of the projector exit aperture impinge on said second planar reflector, are reflected towards said first planar reflector and are reflected from said first planar reflector to impinge on said second major surface at said first angle of incidence.

2. The optical system of claim 1, wherein said second planar reflector is formed at a surface of a prism attached to said first major surface.

3. The optical system of claim 2, wherein said lightguide is formed primarily from a material having a first refractive index and wherein said prism is formed from a material having a second refractive index.

4. The optical system of claim 3, further comprising a compensation wedge formed from material with said first refractive index interposed between said prism and said first major surface.

5. The optical system of claim 3, wherein a portion of said lightguide adjacent to said first planar reflector is formed from a material having said second refractive index, said second refractive index being greater than said first refractive index.

6. The optical system of claim 2, wherein said image projector is integrated with said prism, said image projector comprising a polarizing beam splitter deployed within said prism for directing light from an image plane via reflective collimating optics towards said first and second planar reflectors.

7. The optical system of claim 6, wherein said reflective collimating optics is located behind said second planar reflector and wherein light from the image plane passes through said second planar reflector to reach said reflective collimating optics, is reflected back through said second planar reflector, and is reflected by said polarizing beam splitter at an oblique angle to said second planar reflector for coupling in to said lightguide.

8. The optical system of claim 1, wherein said angle β is between 35 degrees and 55 degrees.

9. The optical system of claim 1, wherein said second planar reflector is perpendicular to said first major surface of said lightguide.
